(19) United States
(12) Patent Application Publication
(10) Pub. No.: US 2016/0007279 A1
(43) Pub. Date: Jan. 7, 2016

(54) METHOD AND APPARATUS FOR TRANSMITTING AGGREGATED QOS INFORMATION IN WIRELESS COMMUNICATION SYSTEM

(71) Applicant: LG ELECTRONICS INC., Seoul (KR)

(72) Inventors: Daewook BYUN, Seoul (KR); Jian XU, Seoul (KR); Insun LEE, Seoul (KR); Youngdae LEE, Seoul (KR); Kyungmin PARK, Seoul (KR)

(73) Assignee: LG ELECTRONICS INC., Seoul (KR)

(21) Appl. No.: 14/768,412

(22) PCT Filed: Mar. 18, 2014
(86) PCT No.: PCT/KR2014/002285

§ 371 Date: Aug. 17, 2015

Related U.S. Application Data
(60) Provisional application No. 61/803,418, filed on Mar. 19, 2013.

(51) Int. Cl. H04W 52/02; H04W 28/08; H04W 28/02

(52) U.S. Cl. CPC H04W 52/0206; H04W 28/0268; H04W 28/08

(57) ABSTRACT

A method and apparatus for transmitting aggregated quality of service (QoS) information in a wireless communication system is provided. A first node which controls a first cell configures a combination of aggregated QoS information for each user equipment (UE) which is receiving services from the first cell, and transmitting the combination of aggregated QoS information to a second node which controls a second cell. Upon receiving information combining aggregated QoS information for each UE from a plurality of first nodes, the second node determines whether to switch off a plurality of first cells based on the received information combining aggregated QoS information for each UE.

### BACKGROUND OF THE INVENTION

1. Field of the Invention

The present invention relates to wireless communications, and more particularly, to a method and apparatus for transmitting aggregated quality of service (QoS) information in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of

UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 2, the RLC and MAC layers (terminated in the eNB on the network side) may perform functions such as scheduling, automatic repeat request (ARQ), and hybrid automatic repeat request (HARQ). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area.

If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULlnterference, TransmitPilot and

Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value In the UL in the signature.

Recently, efforts to reduce a greenhouse effect and environmental degradation by excessive emissions of carbon dioxide have been increased. Accordingly, in wireless communications, issues of reducing power of base stations, which are main cause of emissions of carbon dioxide, and using the power of base stations efficiently have been discussed importantly. That is, until now, it is a focus of discussion of wireless communications that reducing power consumptions of user equipments in order to improve portability. But, in the future, reducing the power consumptions of base stations and increasing efficiency of the power of base stations may be subject to critical discussion. As a result, emissions of carbon dioxide, as well as operational costs (OPEX), can be reduced. Accordingly, necessity for development of technologies which reduce power consumptions of base stations through effective energy consumptions of base stations has been increased.

In 3GPP, discussion of energy saving solutions from the point of view of base stations has started from rel-9, and in rel-12 currently, technologies for energy saving have been discussed in an environment in which coverage of LTE base stations does not overlap each other.

### SUMMARY OF THE INVENTION

The present invention provides a method and apparatus for transmitting aggregated quality of service (QoS) information in a wireless communication system. The present invention provides a method for transmitting aggregated QoS information of each UE for energy saving in an overlapping coverage scenario or a non-overlapping coverage scenario. The present invention provides a method for transmitting a list of aggregated QoS information for each user equipment (UE) or aggregated maximum bit rate (AMBR) of each UE for energy saving.

In an aspect, a method for transmitting, by a first node which controls a first cell, aggregated quality of service (QoS) information in a wireless communication system is provided. The method includes configuring a combination of aggregated QoS information for each user equipment (UE) which is receiving services from the first cell, and transmitting the combination of aggregated QoS information to a second node which controls a second cell.

The aggregated QoS information for each UE may be a UE-aggregated maximum bit rate (AMBR) of each UE.

The combination of aggregated QoS information may be a list of the aggregated QoS information for each UE.

The combination of aggregated QoS information may be a sum of the aggregated

QoS information for each UE.

The first cell may be a capacity booster cell, and the second cell may be a coverage cell.

The first cell may be an energy saving cell, and the second cell may be a compensation cell.

The method may further include triggering an energy saving procedure before transmitting the combination of aggregated QoS information for each UE.

The energy saving procedure may be triggered if load of the first cell is less than a threshold during a specific period of time.

The method may further include receiving a command message, which requests the first node to transmit a request message, from the second node before transmitting the combination of aggregated QoS information for each UE.

The method may further include receiving an indication indicating whether the first node can switch off the first cell or not.

The method may further include switching off the first cell and handing over UEs which are receiving services from the first cell to the second cell.

In another aspect, a method for receiving, by a second node which controls a second cell, aggregated quality of service (QoS) information in a wireless communication system is provided. The method includes receiving information combining aggregated QoS information for each user equipment (UE) from a plurality of first nodes which control a plurality of first cells respectively, and determining whether to switch off the plurality of first cells based on the received information combining aggregated QoS information for each UE.

Whether to switch off the plurality of first cells may be determined by comparing a total of information combining the aggregated QoS information received from the plurality of first nodes and capacity of the second cell.

It may be determined to switch off the plurality of first cells if the total of information combining aggregated QoS information received from the plurality of first nodes is less than the capacity of the second cell.

It may be determined not to switch off the plurality of first cells if the total of information combining aggregated QoS information received from the plurality of first nodes is more than the capacity of the second cell.

QoS information can be considered for energy saving.

### BRIEF DESCRIPTION OF THE DRAWINGS

FIG. 1 shows LTE system architecture.

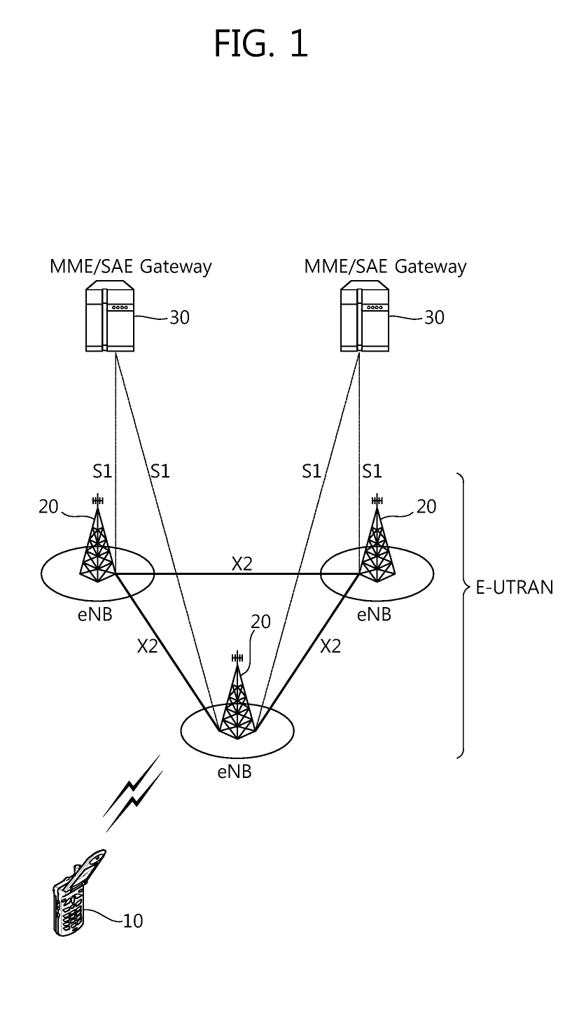

FIG. 2 shows a control plane of a radio interface protocol of an LTE system.

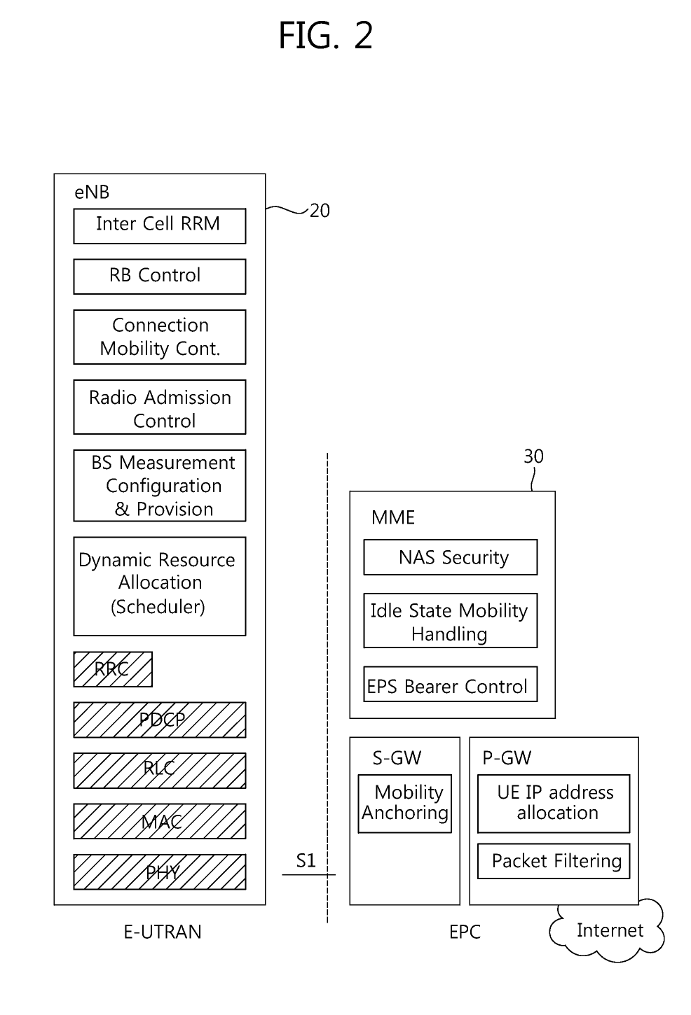

FIG. 3 shows a user plane of a radio interface protocol of an LTE system.

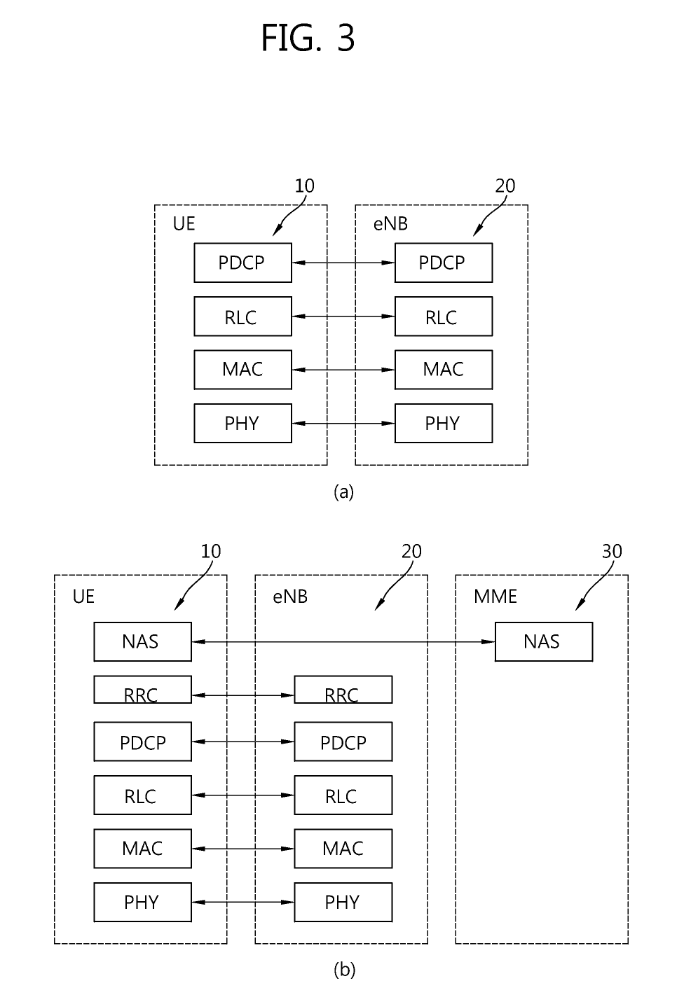

FIG. 4 shows an example of a physical channel structure.

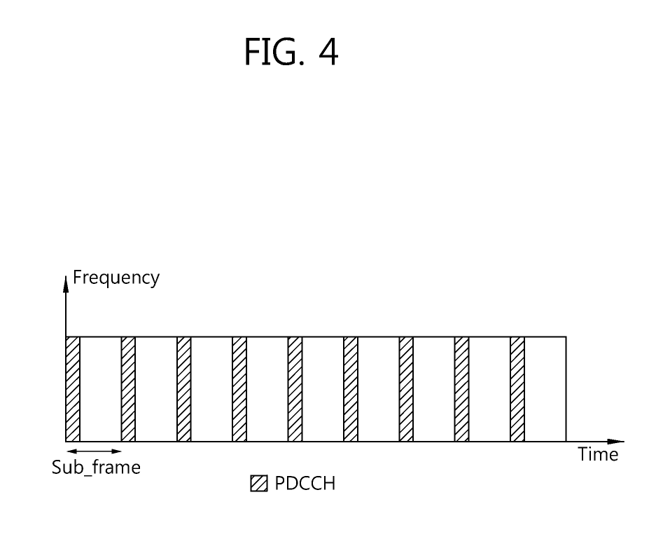

FIG. 5 shows an inter-eNB scenario 1 for energy saving.

FIG. 6 shows an inter-eNB scenario 2 for energy saving.

FIG. 7 shows an example of a method for transmitting aggregated QoS information according to an embodiment of the present invention.

FIG. 8 shows an example of a method for transmitting aggregated QoS information in a non-overlapping coverage scenario according to an embodiment of the present invention.

FIG. 9 shows a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

Inter-eNodeB (eNB) energy saving is described. It may be referred to Section 6 of 3GPP TR 36.927 V11.0.0 (2012-09).

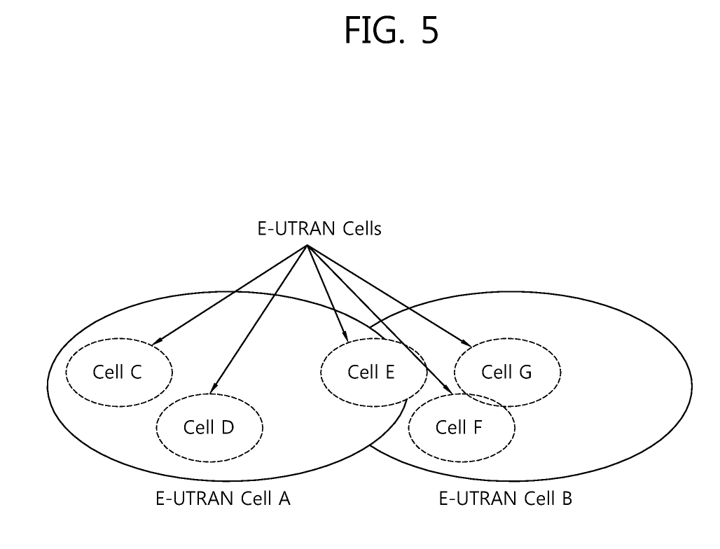

FIG. 5 shows an inter-eNB scenario 1 for energy saving.

The inter-eNB scenario 1 for energy saving may be called an overlapping coverage scenario. Referring to FIG. 5, E-UTRAN cell C, D, E, F and G are covered by the E-UTRAN cell A and B. Here, cell A and B have been deployed to provide basic coverage, while the other E-UTRAN cells boost the capacity. E-UTRAN cells which provide basic coverage may be called a coverage cell, and E-UTRAN cells which boost the capacity may be called a capacity booster cell. When some cells providing additional capacity are no longer needed, they may be switched off for energy optimization. In this case, both the continuity of LTE coverage and service quality of service (QoS) is guaranteed. If all cells have the same multiple public land mobile networks (PLMNs) in a network sharing scenario, there are no issues with the solutions to the inter-eNB scenario 1 for energy saving. In general, inter-eNB energy saving mechanisms should preserve the basic coverage in the network.

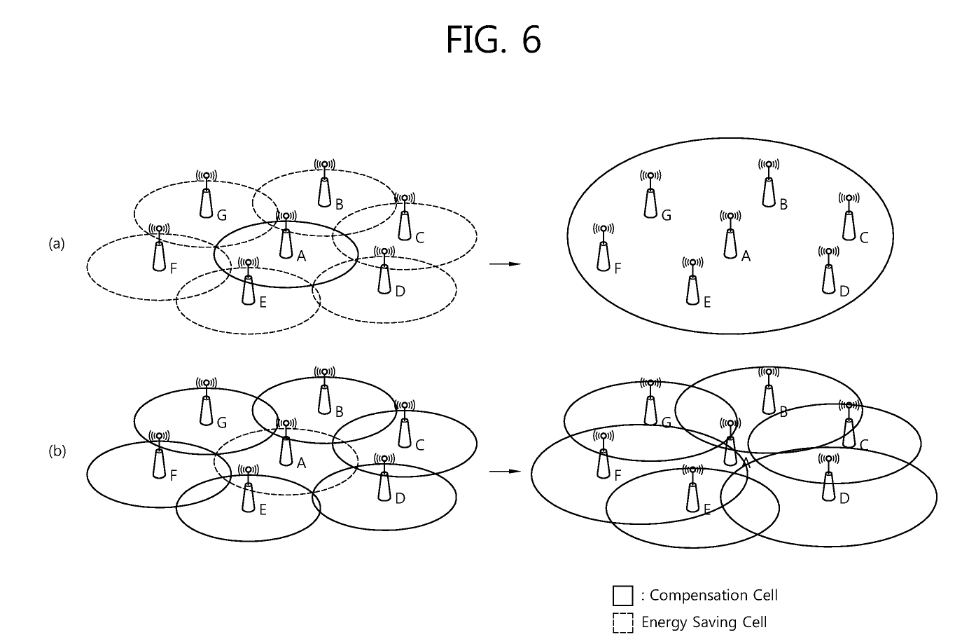

FIG. 6 shows an inter-eNB scenario 2 for energy saving.

The inter-eNB scenario 2 for energy saving may be called a non-overlapping coverage scenario. There may be a base station which has few users when users are not many. In order to reduce energy consumptions of such base station, the base station may be switched off. And, in order to cover service area of the base station which is switched off, a neighboring base station may extend coverage thereof. In this case, a cell served by the base station which is switched off may be called an energy saving cell, and a cell served by the base station which extends coverage may be called a compensation cell.

According to how the energy saving cells and compensation cells operate with each other, the inter-eNB scenario 2 for energy saving may involve two cases. Referring to FIG. 6, FIG. 6-(a) shows a case that cell A is the compensations cell, while other cells are the energy saving cells. That is, the basic coverage is provided by one cell in FIG. 6-(a). FIG. 6-(b) shows a case that cell A is the energy saving cell, while other cells are the compensation cells. That is, the basic coverage is provided by several compensation cells in FIG. 6-(a). For both cases, single layer coverage of E-UTRAN cells is deployed. At off-peak time, energy saving cells may enter dormant mode. In general, the continuity of LTE coverage is guaranteed while the QoS of some services may be impacted.

When load level and distribution fluctuates, some cells may be switched off, but in order to guarantee continuous coverage, others must be kept on or even reconfigured to cover up for those that are in dormant mode. To achieve energy savings in the inter-eNB scenario 2 for energy saving, energy saving approaches can be used. The energy saving approaches are configured by determining which cell is the energy saving cell or compensation cell, how hotspots E-UTRAN cells enters or leaves dormant mode, and how to adjust coverage of the compensation cell. These approaches are as follows.

### 1) Operations and Management (OAM)-Based Approach

All cells are preconfigured as potential compensation cells and energy saving cells.

The decision to enter or leave dormant mode is made based on the proprietary algorithm in each cell configured by the OAM. The neighbor nodes should be informed either by the OAM or by the signaling.

### 2) Signaling-Based Approach

The cells are aware of whether they are compensation cell or energy saving cell based on the OAM or proprietary information which is knowledge by itself, e.g., UE measurements, interference status, load information, etc. The energy saving cell checks load information of itself, and if the load is less than a threshold for a period of time, the energy saving cell decides to enter dormant mode autonomously or based on information exchanged with the compensation cell. At the same time, the energy saving cell will initialize communication with the corresponding compensation cells, and the coverage related information may be included into the request message. The final decision is made at the compensation cell upon receiving the request message, and the feedback may be needed. If the energy saving cell enters the dormant mode, the compensation cell extends coverage of itself in order to cover service area of served by the energy saving cell.

### 3) Hybrid OAM and Signaling-Based Approach

The cells are preconfigured as potential compensation cells or energy saving cells by the OAM, and also the OAM communicates to all cells, the values of some parameters that determine the behavior of switching on/off mechanisms.

In the description below, the signaling-based approach for inter-eNB scenario for energy saving may be considered. The signaling-based approach has a problem that the energy saving cell decides to enter the dormant mode considering cell load of the energy saving cell, but not considering users in the energy saving cell. For example, it is assumed that two users are served by the energy saving cell. It is assumed that one user of the two users is receiving a high capacity service from the energy saving cell, and the other user of the two users is receiving a low capacity service from the energy saving cell. When considering cell load from the perspective of the energy saving cell, if the cell load by the two users is less than a threshold which can trigger communications with the compensation cell, the energy saving cell may transmit the request message to the compensation cell. Upon receiving the request message, the compensation cell may decide whether the energy saving cell enters the dormant mode or not. If it is decided that the energy saving cell enters the dormant mode, the two users served by the energy saving cell may be handed over to the compensation cell. The user which is receiving the high capacity service from the energy saving cell may receive the low capacity service from the compensation cell according to a situation of the compensation cell. That is, QoS degradation may occur.

Hereinafter, a method for transmitting aggregated QoS information according to embodiments of the present invention is described. The following description will mainly focus on the inter-eNB scenario 2 for energy saving, i.e., non-overlapping coverage scenario. However, technical features of the present invention are not limited thereto, and the present invention may be applied to the inter-eNB scenario 1 for energy saving, i.e., overlapping coverage scenario.

As described above, in order to avoid QoS degradation by handover performed before switching off the energy saving cell or capacity booster cell, the bearer level QoS parameter values assigned by an evolved packet core (EPC) may be considered as UE QoS requirement when to switch off the energy saving cell or capacity booster cell. Since the eNB may know bearer level QoS parameter values through the messages transmitted by a mobility management entity (MME), it may perform the functions related to energy saving using these QoS parameter values.

In the non-overlapping coverage scenario, when the energy saving cell decides to switch off due to energy saving, one possible solution considering UE QoS requirement is to use the UE-aggregated maximum bit rate (AMBR) of the UE. The UE-AMBR limits the aggregate bit rate that can be expected to be provided across all non-guaranteed bit rate (GBR) bearers of a UE. If the compensation cell can support this value of the UE which camps on the energy saving eNB which wants to go into dormant mode, this UE is able to be handed over to the compensation cell before the energy saving cell switches off and QoS degradation for service provided to this UE does not occur. In order to determine whether the compensation cell can accommodate the UE-AMBR or not, the energy saving cell may provide the compensation cell with the UE-AMBR of the UE it covers.

Likewise, in the overlapping coverage scenario, before starting handover procedure to switch off, the capacity booster cell provides the coverage cell with the UE-AMBR of the UE. If the coverage cell can allocate all resources corresponding to information transmitted for all of UEs which camps on the capacity booster cell, these UEs can be handed over and their QoS requirements are able to be guaranteed fully. Otherwise, handover is not performed because QoS of each UE cannot be guaranteed.

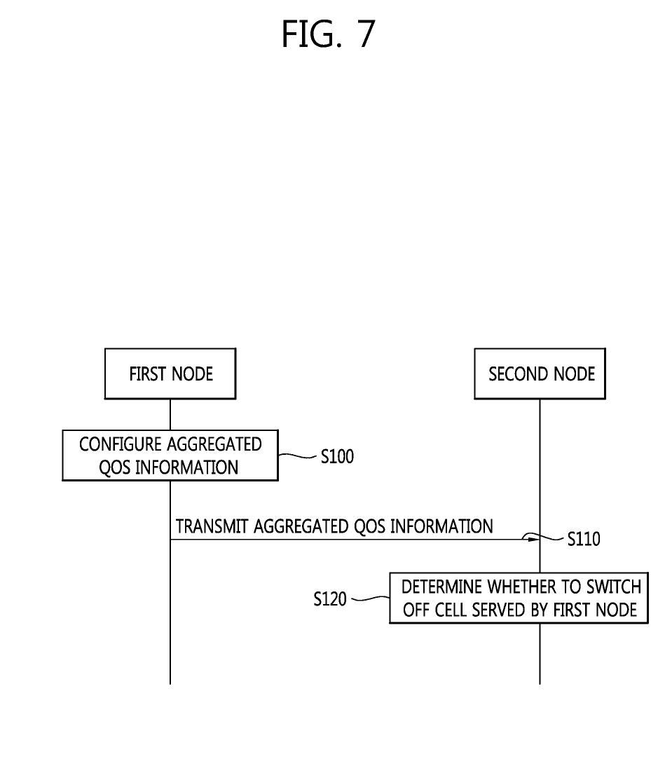

FIG. 7 shows an example of a method for transmitting aggregated QoS information according to an embodiment of the present invention.

In step S100, a first node configures aggregated QoS information of a UE which is receiving services from a first cell controlled by the first node. The aggregated QoS information may be the UE-AMBR of the UE. The first node may combine aggregated QoS information of each UE. The combined aggregated QoS information may be a list of aggregated QoS information. Or, the combined aggregated QoS information may be sum of UE-AMBR of each UE.

In step S110, the first node transmits the aggregated QoS information or combined aggregated QoS information to a second node which controls a second cell. The aggregated QoS information or combined aggregated QoS information may be transmitted via an existing message in 3GPP LTE, e.g., eNB configuration update message, or a newly defined message for aggregated QoS information or combined aggregated QoS information.

In step S120, the second node determines whether to switch off the first cell. In the overlapping coverage scenario, the first cell may be the capacity booster cell, and the second cell may be the coverage cell. In the non-overlapping coverage scenario, the first cell may be the energy saving cell, and the second cell may be the compensation cell.

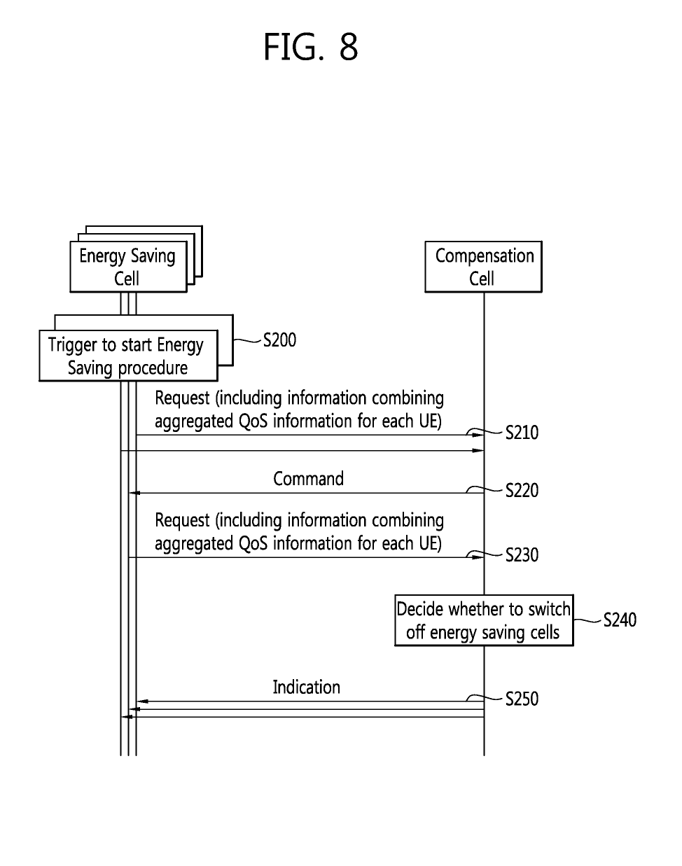

FIG. 8 shows an example of a method for transmitting aggregated QoS information in a non-overlapping coverage scenario according to an embodiment of the present invention.

In step S200, the energy saving cell triggers an energy saving procedure which performs communication with the compensation cell if the cell load of the energy saving cell is maintained as less than a threshold for a predetermined period of time. This step may be performed by one or more energy saving cells.

In step S210, upon triggering the energy saving procedure, one or more energy saving cells transmit a request message which includes information combining aggregated QoS information for each UE. The information combining aggregated QoS information for each UE may be a list of aggregated QoS information for each UE, or the sum of UE-AMBR of each UE.

In step S220, upon receiving the request message from the one or more energy saving cells, the compensation cell transmits a command message to the remaining energy saving cells. The remaining energy saving cell is configured as the energy saving cell by the OAM but does not transmit the request message, yet. If there is no remaining energy saving cell, this step may be skipped.

In step S230, upon receiving the command message from the compensation cell, the remaining energy saving cells transmit a request message which includes information combining aggregated QoS information for each UE. The information combining aggregated QoS information for each UE may be a list of aggregated QoS information for each UE, or the sum of UE-AMBR of each UE. If there is no remaining energy saving cell, this step may be skipped.

In step S240, upon receiving the request message from the remaining energy saving cells, the compensation cell decides whether to switch off all of the energy saving cells. The compensation cell compares the total of information combining aggregated QoS information for each UE with capacity which can be provided by the compensation cell currently. If the total of information combining aggregated QoS information for each UE is smaller than the capacity which can be provided by the compensation cell, it means that the compensation cell can support UEs which is receiving services from all of the energy saving cells. In this case, all of the energy saving cells can be switched off. Otherwise, all of the energy saving cells cannot be switched off. The total of information combining aggregated QoS information for each UE may be the total of aggregated QoS information in the list of aggregated QoS information transmitted by all of the energy saving cells. Or, the total of information combining aggregated QoS information for each UE may be the total of the sum of UE-AMBR of each UE transmitted by all of the energy saving cells.

In step S250, the compensation cell transmits an indication, which indicates whether all of the energy saving cells can be switched off, to all of the energy saving cells.

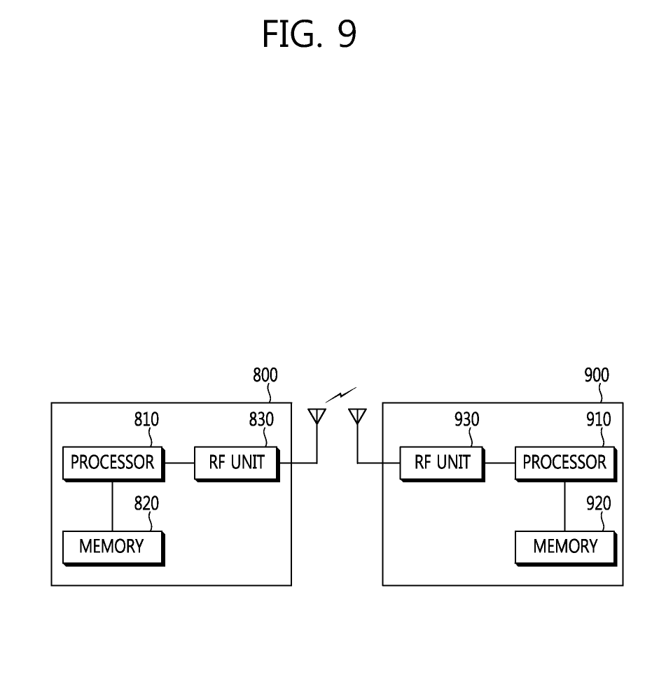

FIG. 9 shows a wireless communication system to implement an embodiment of the present invention.

A first node 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second node 900 may include a processor 910, a memory 920 and a RF unit 930.

The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for transmitting, by a first node which controls a first cell, aggregated quality of service (QoS) information in a wireless communication system, the method comprising:
configuring a combination of aggregated QoS information for each user equipment (UE) which is receiving services from the first cell; and
transmitting the combination of aggregated QoS information to a second node which controls a second cell.

2. The method of claim 1, wherein the aggregated QoS information for each UE is a UE-aggregated maximum bit rate (AMBR) of each UE.

3. The method of claim 1, wherein the combination of aggregated QoS information is a list of the aggregated QoS information for each UE.

4. The method of claim 1, wherein the combination of aggregated QoS information is a sum of the aggregated QoS information for each UE.

5. The method of claim 1, wherein the first cell is a capacity booster cell, and wherein the second cell is a coverage cell.

6. The method of claim 1, wherein the first cell is an energy saving cell, and wherein the second cell is a compensation cell.

7. The method of claim 1, wherein the combination of aggregated QoS information for each UE may be transmitted via eNodeB (eNB) configuration update message or a newly defined message.

8. The method of claim 1, further comprising:
triggering an energy saving procedure before transmitting the combination of aggregated QoS information for each UE.

9. The method of claim 8, wherein the energy saving procedure is triggered if load of the first cell is less than a threshold during a specific period of time.

10. The method of claim 1, further comprising:
receiving a command message, which requests the first node to transmit a request message, from the second node before transmitting the combination of aggregated QoS information for each UE.

11. The method of claim 1, further comprising:
receiving an indication indicating whether the first node can switch off the first cell or not.

12. The method of claim 1, further comprising:
switching off the first cell and handing over UEs which are receiving services from the first cell to the second cell.

13. A method for receiving, by a second node which controls a second cell, aggregated quality of service (QoS) information in a wireless communication system, the method comprising:
receiving information combining aggregated QoS information for each user equipment (UE) from a plurality of first nodes which control a plurality of first cells respectively; and
determining whether to switch off the plurality of first cells based on the received information combining aggregated QoS information for each UE.

14. The method of claim 13, wherein whether to switch off the plurality of first cells is determined by comparing a total of information combining the aggregated QoS information received from the plurality of first nodes and capacity of the second cell.

15. The method of claim 14, wherein it is determined to switch off the plurality of first cells if the total of information combining aggregated QoS information received from the plurality of first nodes is less than the capacity of the second cell.

16. The method of claim 14, wherein it is determined not to switch off the plurality of first cells if the total of information combining aggregated QoS information received from the plurality of first nodes is more than the capacity of the second cell.
